(19) United States
(12) Patent Application Publication
(10) Pub. No.: US 2024/0239457 A1
(43) Pub. Date: Jul. 18, 2024

(54) AN UNDERWATER PROBE OR SUBMERSIBLE

(71) Applicant: UAM Tec Pty Ltd, Port Melbourne, Victoria (AU)

(72) Inventors: Shawn Taylor, Port Melbourne, Victoria (AU); Alex Cutri, Port Melbourne, Victoria (AU); Khang Nguyen, Port Melbourne, Victoria (AU); Sarmad Yousif, Port Melbourne, Victoria (AU); Thanh Le, Port Melbourne, Victoria (AU)

(21) Appl. No.: 18/562,952

(22) PCT Filed: May 24, 2022
(86) PCT No.: PCT/AU2022/050496

§ 371 Date: Nov. 21, 2023

(30) Foreign Application Priority Data
May 25, 2021 (AU) 2021901560

(51) Int. Cl. B63G 8/00; B63B 3/13; B63G 8/22; B63G 8/38

(52) U.S. Cl. CPC B63G 8/001; B63B 3/13; B63G 8/22; B63G 8/38; B63G 2008/005

(57) ABSTRACT

An underwater probe (11) comprises a submersible body having an elongated body with a hydrodynamic effective shape for travel in at least one longitudinal direction. There is a power system including two longitudinal side thrusters (21) for allowing the controllable driving of the submersible body in the at least one longitudinal direction and a top thruster (22) for allowing maneuvering in a lateral plane to the longitudinal axis E-E. Also, there is a visual image capture system including a plurality of optical cameras (31, 35) locatable on or at the surface of the elongated body. The probe is modular and has readily connectable and disconnectable modules that can be reconfigured to readily form differing volume and different payload ballast remotely controllable adjustable buoyant probes.

### CROSS-REFERENCE TO RELATED APPLICATIONS

This application is a 371 National Phase Entry of International Patent Application No. PCT/AU2022/050496 filed on May 24, 2022, which claims the benefit of Australian Patent Application No. 2021901560 filed on May 25, 2021, the contents of which are incorporated herein by reference in their entirety.

### FIELD OF THE INVENTION

The present invention relates to underwater probes and in particular to an underwater probe or submersible for use in data gathering.

The invention has been developed primarily for use in/with underwater topological review and mapping of natural growths and formations and particularly Underwater Autonomous Mapping and will be described hereinafter with reference to this application. However, it will be appreciated that the invention is not limited to this particular field of use.

### BACKGROUND OF THE INVENTION

Submersibles can be of various sizes and shapes and due to their configuration incur different problems. Large submersibles such as submarines require large engines and therefore generally have a rear propeller for driving forward. This causes substantial turbulence through which one cannot collect data. Also, such large submersibles only proceed readily in the forward direction but need considerable maneuvering to move in any other direction.

Such submersibles are generally not suitable or versatile enough for data gathering such as underwater topological review and mapping of natural growths and formations.

Fast submersibles can have problems of instability due to hydrodynamic effects. Just like airplanes need aerodynamic structures to keep stability, fast submersibles need protruding fins to keep hydrodynamic stability. Usually if speed is the aim, then a single direction is the result and fins will protrude causing turbulence and affecting image viewing in any but forward direction.

Again, such submersibles are generally not suitable or versatile enough for data gathering such as underwater topological review and mapping of natural growths and formations.

It is therefore beneficial to have slow small versatile and readily maneuverable submersibles.

Another main complication with such submersibles is that no longer can you be on board to drive such vehicles; it is necessary to remotely control and/or self-drive small submersibles. The usual control systems used with vehicles above ground, such as radio triangulation or Global Position Satellite (GPS) control is not readily usable with controlling submersibles and is not consistent due to the effects of different depths, different salinity, different underwater geology etc. This can be due to a range of transmission complications such as reflection, refraction or differing doppler effects, just to name a few problems.

On large or sophisticated submersibles higher technology can be used to try to counter these effects. Such is not available to fit on small submersibles or to be cost effective on small submersibles.

It can be seen that known prior art underwater probe has the problems of:
(a) causing turbulence and therefore reduces optical effects;
(b) not usable in shallow water;
(c) requiring large areas for maneuverability;
(d) not versatile or adaptable; and
(e) no known ability with speed and accuracy.

The present invention seeks to provide underwater probes which will overcome or substantially ameliorate at least one or more of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to the present invention, there is provided an underwater probe, usable in a network of underwater probes, the underwater probe comprising: a submersible body having: an elongated body with a hydrodynamic effective shape for travel in at least one longitudinal direction; a power system for allowing the controllable driving of the submersible body in the at least one longitudinal direction; a visual image capture system including a plurality of optical cameras locatable on or at the surface of the elongated body to allow for usage in one or more of:
navigation;
a visual capture;
a visual mapping;
knitting of a composite visual image.

Preferably the elongated body with the hydrodynamic effective shape is symmetrical for travel in at least two opposing longitudinal directions. It can include a hydrodynamic effective shape including a first and a second opposing substantially conical heads and a main cylindrical central part therebetween with each aligned along a common elongated axis to allow the hydrodynamic effective shape for travel in at least two opposing directions. That direction is along the longitudinal axis.

Preferably the main cylindrical central part and the first and the second opposing substantially conical heads are detachable and replaceable. The main cylindrical part can be replaced by a differing length of the main cylindrical part and with the first and the second opposing substantially conical heads attached to each end.

The main cylindrical central part or the differing length main cylindrical central part can include payload of one or more of:
(a) batteries;
(b) ballast;
(c) motors;
(d) electronics;
(e) data and power connections; and
(f) other payloads.

The elongated body of the underwater probe is substantially in the range of 1 to 5 meters long but preferably is substantially 1 to 1.5 meters long. The elongated body can be substantially elliptical with a 1- to 1.5-meter major axis and a 0.3- to 0.5-meter minor axis.

The power system allows for the controllable driving of the submersible body is a 3-degree of freedom maneuvering system, where it can move in the at least two opposing directions along the axis of the elongated shape, up and down, left and right. Preferably the power system includes two side thrusters on either side of the elongated body and a top thruster on a top surface wherein the top thrusters of the power system on the top side of the elongated body include 2 motors spinning in opposite directions to counter the angular momentum of each single motor. The two side thrusters of the power system on either side of the elongated body are under the center of gravity plane wherein the probe is maintained stable during maneuvering.

The plurality of optical cameras of the visual image capture system includes one or more of:
a monoscopic camera; and
a stereoscopic camera.

Preferably the optical cameras include stereoscopic cameras for steering the underwater probe and can be located at either end of the elongated body and form part of the hydrodynamic effective shape.

Also, preferably the optical cameras include monoscopic cameras for visual mapping. The monoscopic cameras are wide angled cameras substantially in the range of 90° to 180° scope.

Preferably the monoscopic cameras are mounted on the nose part of the submersible. In particular a plurality of the monoscopic cameras is mounted in a ring on the surface of a nose part on a plane rectilinear to the longitudinal axis of the submersible. With two opposing nose parts preferably the plurality of opposing nose parts each have a ring of a plurality of the monoscopic cameras on a plane rectilinear to the longitudinal axis of the submersible wherein the planes of each of the rings is parallel and spaced to each other to provide relativistic scanning at separate timing as the submersible moves in one or other of the opposing directions along the longitudinal axis.

The plurality of the monoscopic cameras forming the ring of cameras to provide adequate coverage without dead spots is determined by the relationship is defined as:

$$x = \frac{r sin ( 180 - \frac{1}{2} θ )}{sin ( \frac{1}{2} θ - \frac{1}{2} β )} - r$$

where θ=the camera view angle, x=distance between the camera lens and the first overlap with adjacent camera, r=radius of the submersible at the axis of the cameras, β=angular spacing of cameras=360°/N, and N=number of cameras.

Preferably each of the plurality of the monoscopic cameras is mounted on the surface of the nose in a tangential alignment relative to the longitudinal axis.

However more preferably each of the plurality of the monoscopic cameras are mounted on the surface of the nose in a rectilinear alignment to the plane and parallel to the longitudinal axis.

The invention also provides an underwater probe for use in a network of underwater probes each obtaining a localized panorama, the underwater probe comprising: a submersible body having: an elongated body with a hydrodynamic effective shape for travel in at least one direction; a power system for allowing the controllable driving of the submersible body in the at least one direction; a visual image capture system including a plurality of optical cameras locatable on or at the surface of the elongated body to allow for usage in multiple image capture for use in providing a localized panorama formed by the optical cameras locating an object or the lack of an object in a predefined focused distance from the elongated body and allowing the localized panorama for use in creating an interlinked panorama by the network of underwater probes; and a navigation system providing a relativized panorama formed by the optical cameras locating an object or the lack of an object in a predefined focused distance from the elongated body and within a calculated time and or distance locating an object or the lack of an object in a predefined focused distance from the elongated body allowing the localized panorama.

Preferably a plurality of opposing nose parts each have a ring of a plurality of monoscopic cameras being wide angled cameras substantially in the range of 90° to 180° scope wherein each ring is on a plane rectilinear to the longitudinal axis of the submersible wherein the planes of each of the rings is parallel and spaced to each other to provide relativistic scanning at separate timing as the submersible moves in one or other of the opposing directions along the longitudinal axis.

The at least one input device provides for use in creating an interlinked panorama by digital knitting of each localized panorama of a network of underwater probes. Preferably, the at least one input device provides for use in creating an interlinked relativized panorama by digital knitting of each relativized panorama of a network of underwater probes. The panorama is then a captured visual panorama. This panorama can be a digitally mapped panorama determined from the interlinked panorama or interlinked relativized panorama.

The monoscopic cameras are preferably wide angled cameras or panoramic cameras substantially in the range of 90° to 180° scope.

The panoramic cameras are mounted on the elongated body and can be mounted on the elongated body to protrude to allow panoramic views while minimizing effect to the hydrodynamic effective shape.

Preferably the panoramic cameras are mounted in curved domes with protruding elevation in the range of 4% to 8% of the maximum diameter of the underwater probe around the elongated axis. There can be 5 to 9 but preferably 7 panoramic cameras are equally spaced from the leading point of and equally spaced around the 360° of the leading substantially conical head aligned along a common elongated axis.

Preferably the leading substantially conical head is aligned along a common elongated axis has converging opposed tangential lines that extend to about the required predefined focused distance from the elongated body in front of the hydrodynamic effective shape such that the panoramic cameras are mounted on the tangential line on the hydrodynamic effective shape and thereby can locate an object or the lack of an object in a predefined focused distance in a hemispherical position from the elongated body allowing the localized panorama.

The optical cameras locating an object or the lack of an object in a predefined focused distance from the elongated body includes interpreting an object to be in one of a plurality of categories including:
(a) waterway floor;
(b) solid object;
(c) semisolid object such as sand bar;
(d) moving flora;
(e) fixed flora;
(f) moving fauna; and
(g) fixed fauna.

The invention also provides a method of using an underwater probe for use in a network of underwater probes each obtaining a localized panorama including the steps of:
(a) providing a submersible body having an elongated body with a hydrodynamic effective shape for travel in at least one direction;
(b) driving the submersible body at a fixed spacing to a predetermined extended surface;
(c) undertaking visual capture to undertake:
   (i) locating an object or the lack of an object in a predefined focused distance from the elongated body and allowing the localized panorama for use in creating an interlinked panorama by the network of underwater probes; and
   (ii) locating an object or the lack of an object in a predefined focused distance from the elongated body and within a calculated time and or distance locating an object or the lack of an object in a predefined focused distance from the elongated body allowing the localized panorama;
(d) wherein the predetermined extended surface is the waterway floor; and
(e) wherein the fixed spacing to a predetermined extended surface is about 2 meters (depending on water quality).

The undertaking of visual capture includes the steps of:
(i) provide a location fixed relative location of a plurality of cameras;
(ii) providing control signal operation to each of the location fixed relative location of a plurality of cameras;
(iii) each camera separately upon receipt of control signal checking with global clock; and
(iv) undertake the control action at the next predetermined particular time control point.
   wherein images are provided that are with a fixed relative location and with a fixed relative synchronized time and allowing knitting of images with a fixed relative location and with a substantially relative synchronized time.

It can be seen that the invention of underwater probe provides the benefit of Underwater Autonomous Mapping (UAM) providing the ability to map, search, navigate and learn about our oceans, lakes, and waterways as never before. We can do this when required, as often as required, and far less expensively and more effectively than any mapping technology available today.

UAM submersible of the invention can:
survey our oceans and waterways in detail down to grids of 2 square meters;
search for minerals and other natural resources in images;
research aquatic plants and animals;
grow our knowledge of subsea seismic events;
better know where to work underwater, e.g., cable placement without damaging aquatic habitats; and
search for lost craft.

Other aspects of the invention are also disclosed.

### BRIEF DESCRIPTION OF THE FIGURES

Notwithstanding any other forms which may fall within the scope of the present invention, preferred embodiments of the invention will now be described, by way of example only, with reference to the accompanying drawings in which:

FIG. 1 is a diagrammatic view of a submersible in accordance with a preferred embodiment of the present invention showing a submersible body, a power system for allowing the controllable driving of the submersible body in the at least one longitudinal direction and a visual image capture system including a plurality of optical cameras locatable on or at the surface of the elongated body;

FIG. 2 is a diagrammatic overhead partial view of the submersible of FIG. 1 showing the top motor of the power system;

FIG. 3 is a diagrammatic view of a submersible of FIG. 1 showing the center of gravity plane and the thruster force plane of the main motor of the power system;

FIG. 4 is a diagrammatic view of a submersible of FIG. 1 showing the parts or sections of the submersible;

FIG. 5 is a diagrammatic view of a submersible of FIG. 1 showing the detachability of the parts or sections of the submersible and possible differing central part with two nose parts at either end;

FIG. 6 is a diagrammatic view of a submersible of FIG. 1 showing preferred spacing of the two nose parts at either end to avoid cameras being required in a central part;

FIG. 7 is a diagrammatic view of a submersible of FIG. 1 showing the payload use of the central part with two nose parts at either end;

FIG. 8 is diagrammatic views of a proposed male and female connector that can be used as the power and data connection of the submersible in accordance with an embodiment of the invention;

FIGS. 9 and 10 are diagrammatic exploded views of the male and female connector of FIG. 8 in accordance with an embodiment of the invention;

FIG. 11 is a diagrammatic view of the submersible of FIG. 1 showing the surfacing level S-S to allow surfacing and connection of data and/or power connectors such as in FIGS. 8 and 9 to the submersible;

FIGS. 12 and 13 are diagrammatic views of monoscopic wide angle cameras that can be used as the wide-angle cameras of FIG. 1

FIG. 14 is a diagrammatic of the submersible of FIG. 1 showing the tangential orientation of the optical cameras locatable on or at the surface of the elongated body;

FIG. 15 is a diagrammatic view of the resultant distorted image obtained from the tangential orientation of the optical cameras if 180° or “fisheye” cameras of FIG. 15;

FIG. 16 is a diagrammatic of the submersible of FIG. 1 showing a preferred rectilinear orientation to the longitudinal central axis of the submersible of the 180° optical cameras and showing the arrangement of a ring of the 180° optical cameras locatable on the surface of the elongated body around circumference A-A or B-B;

FIG. 17 is a cross-sectional diagrammatic view around circumference A-A or B-B of FIG. 16 showing the rectilinear orientation of the optical cameras;

FIG. 18 is a diagrammatic view of the overlapping images provided by the multiple cameras of FIG. 17;

FIG. 19 is a diagrammatic view of the resultant “flat” image obtained from the rectilinear orientation of the optical cameras of FIGS. 16 to 18;

FIG. 20 is a diagrammatic view of the angles involved in determining overlap of particular wide angled cameras at particular diameter (twice radius r) such as in FIGS. 16 to 19;

FIG. 21 is a diagrammatic flow diagram of a synchronicity control of the plurality of cameras such as in FIGS. 16 to 19;

FIG. 22 is a diagrammatic view of the effective merging of images by resultant “flat” images obtained from each of the rectilinear orientation of the optical cameras of FIGS. 13 and 14 at circumference A-A and at B-B;

FIG. 23 is a diagrammatic view of a swarm of submersibles that can be used in coordination;

FIG. 24 is a diagrammatic view of the effective digital knitting of merged of resultant “flat” images obtained from each of the submersibles in the swarm of submersibles of FIG. 23; and

FIG. 25 is a diagrammatic flow diagram of the steps in a method of using an underwater probe for use in a network of underwater probes each obtaining a localized panorama.

### DETAILED DESCRIPTION OF SPECIFIC EMBODIMENTS

It should be noted in the following description that like or the same reference numerals in different embodiments denote the same or similar features.

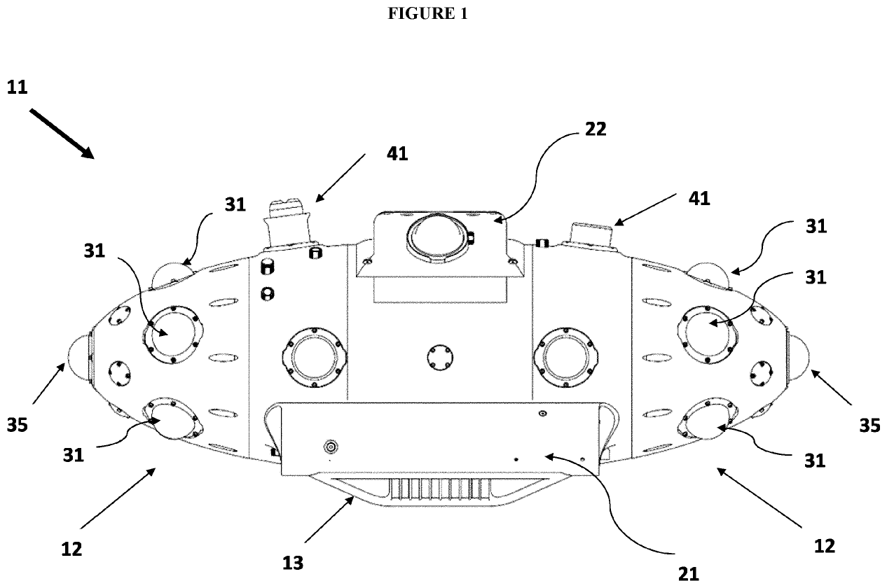

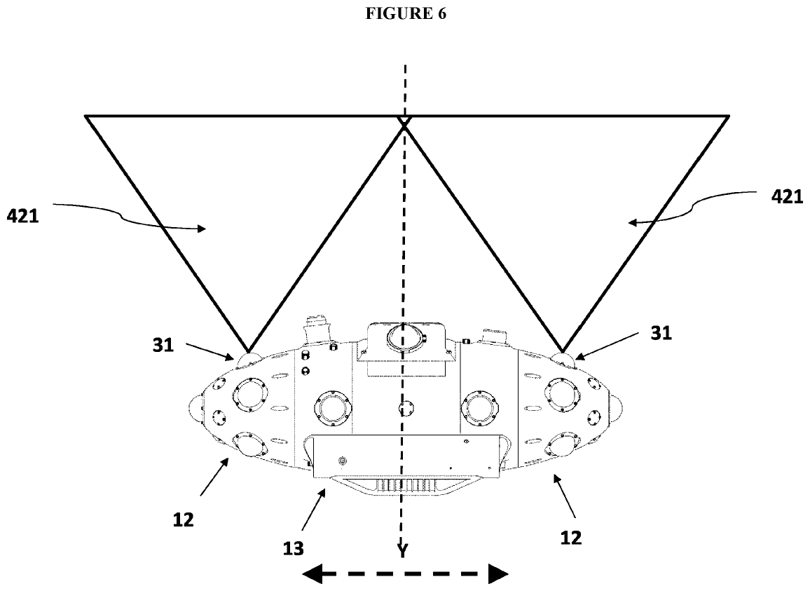

Referring to the drawings and particularly FIGS. 1 to 7, there is shown an underwater probe (11), usable in a network (111) of underwater probes. The underwater probe (11) comprises a submersible body having an elongated body with a hydrodynamic effective shape for travel in at least one longitudinal direction. There is a power system including two longitudinal side thrusters (21) for allowing the controllable driving of the submersible body in the at least one longitudinal direction and a top thruster (22) for allowing maneuvering in a lateral plane to the longitudinal axis E-E. Also, there is a visual image capture system including a plurality of optical cameras (31, 35) locatable on or at the surface of the elongated body.

### Body Structure

The body structure is a combination of body size, body shape and body sections and body material. It is also relevant for motor location.

### (a) Body Size

It is important to keep the body size of the submersible (11) with the underwater probe being substantially in the range of 1 to 5 meters long and more preferably substantially 1 to 1.5 meters long. In this way the buoyancy is readily maintained and can be powered with a battery power source (61) and allowing remote control or self-driving especially with the use of artificial intelligence of the visual capture system.

### (b) Body Shape

It is important to keep the body shape of the underwater probe as a simple primarily opposing bidirectional apparatus such that side elongated main thruster motors (21) can provide the power in those opposite longitudinal axial directions.

The elongated body (11) is symmetrical both around a central longitudinal axis E-E and around a central lateral axis with a substantially circular cross section for travelling in at least two opposing longitudinal directions. However, the cross-sectional shape can be an elliptical or slightly flattened shape. The elongated body can be substantially elliptical with a 1- to 1.5-meter major axis and a 0.3- to 0.5-meter minor axis.

In general form the body shape can have a substantially cylindrical central part (13) and two opposing nose parts (12) at each end. To keep the hydrodynamic effect the nose parts can be conical or bulbous.

The shaping and configuration of the submersible is controlled so that the overall drag coefficient is in the range of 0.70 to 0.80 and preferably 0.75. This allows for easy powering and maneuverability through the water. The drag coefficient is achieved by a combination of front-end shape, smooth continuous outer surface with limited camera protrusions in bubble windows to allow effective use and with reduced drag rear end. However, as the drag coefficient needs to be similar in both major directions then there is a symmetrical shape of one end to the other. In this way there is no preferred direction of the mainly bidirectional device. Clearly though the submersible can steer laterally to the elongated axis of the submersible.

### (c) Body Sections

It is important to keep the body sections with the underwater probe being symmetrical so that there is clear bidirectional operation. This allows ready scanning of a section by forward and reverse motion, without any optical detriment. It also allows for ready reversing when encountering a solid material or an underwater hazard such as trees, plant growth, coral, and other natural hazards. There can be a need for an emergency evacuation maneuvering due to fish or other aquatic animal dangers. Still further other waterway vehicle hazards might require detours or sudden stabilizing action. Stabilization generally occurs while in motion rather than while stationary.

The main design decisions were to create a probe body, with a unique shape (parabolic or domed end caps, and cylindrical body), that could be adapted to different environments with the adding and removing of external “modules.” These modules would be (most often) cylindrical in shape and extend the capability of the probe for different conditions, tasks, or environments. As an example, see below two iterations of our probe, optimized for different environments:

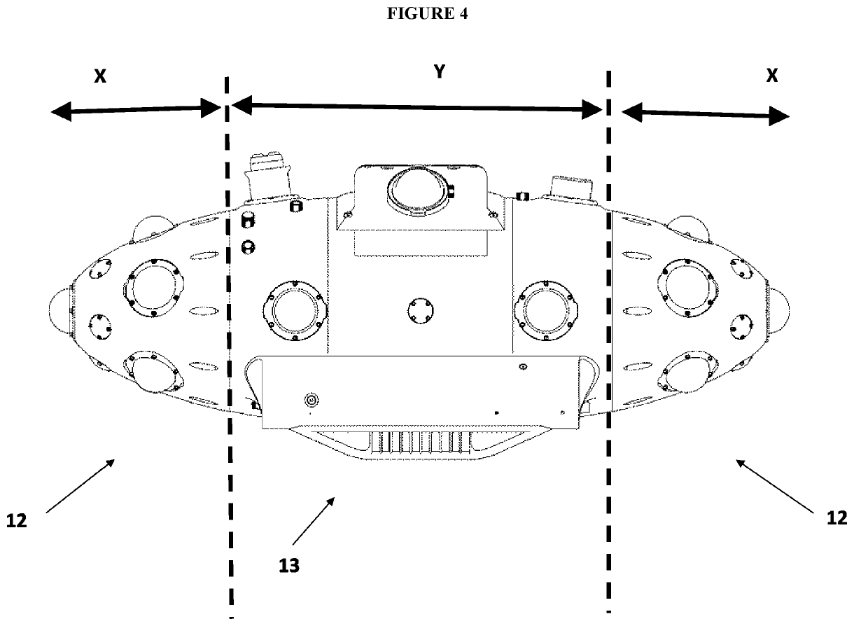

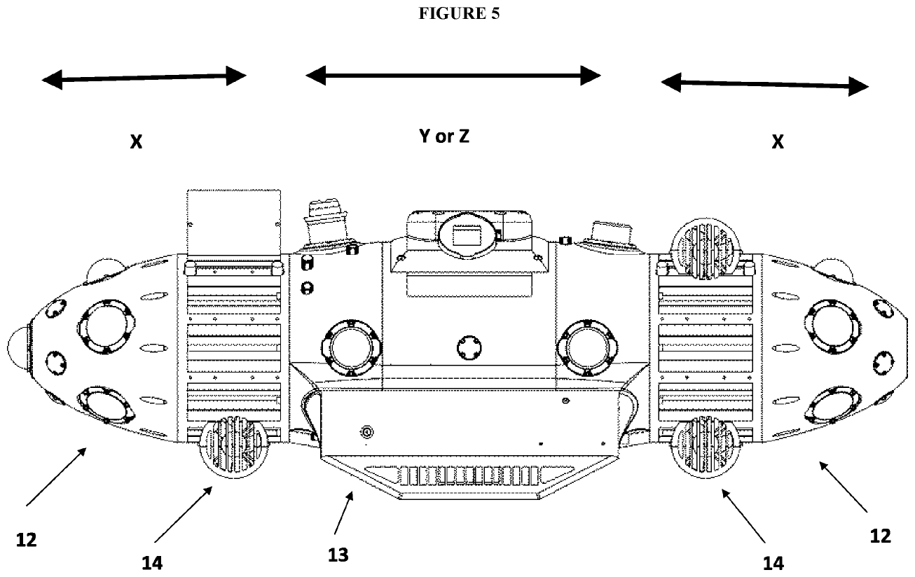

As shown in FIGS. 4 and 5 the elongated body of the underwater probe (11) includes a first and a second opposing substantially conical head (12) with a main cylindrical part (13) therebetween and aligned along a common elongated axis to allow the hydrodynamic effective shape for travel in at least two opposing directions.

An underwater probe can have the main cylindrical central part (13) and the first and the second opposing substantially conical nose heads (12) being detachable and replaceable. Therefore, any nose head (12) that has faulty camera or connections can be readily replaced and repaired while the submersible is able to continue operation with a new nose part (12).

Also as shown in FIG. 5 the main cylindrical part (13) can be replaced by a differing length main cylindrical part and attached to the first and the second opposing substantially conical heads. An underwater probe with the main cylindrical part having a differing length main cylindrical part can include the payload. This probe was set up for semiautonomous, confined space operation in tunnels. This inclusion of the “extension modules” allows for the addition of multiple battery packs (increased payload) and added lateral thrusters.

The overall cylindrical body shaped and domed end caps are maintained despite these modifications, and the overall camera configuration, and other design aspects, are preserved.

### (d) Body Material

The body can be made from stainless steel. However, this will require constant cleaning. The body is preferably formed of aluminum that has Alodine and/or anodized treatment. This requires little if any cleaning.

### Payload

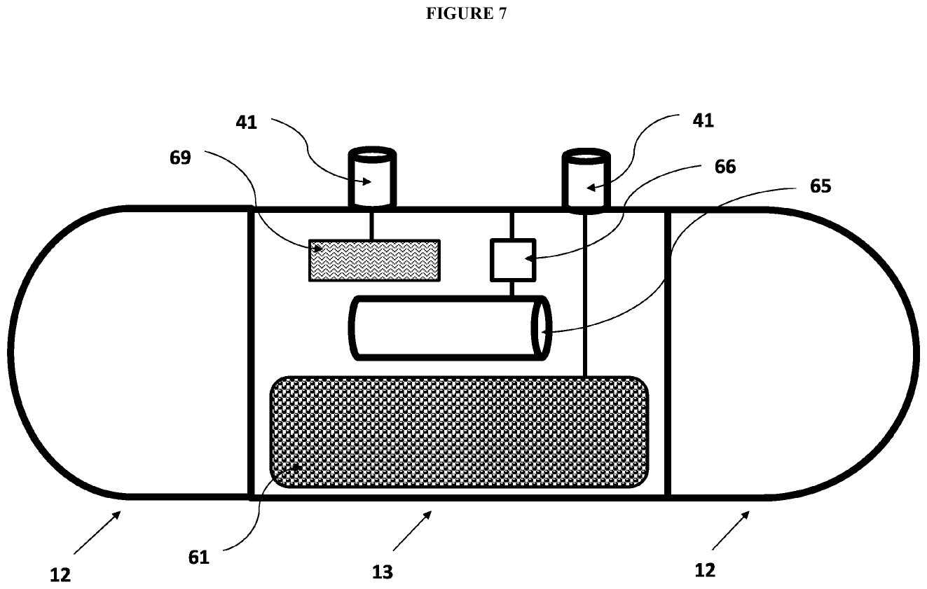

Referring to FIG. 7, the payload is generally locatable in the central part (13) of the body of the submersible and can be categorized into batteries (61), ballast (65), electronics (69), and other payloads. The size of the central part can be varied to allow different payloads and to allow replaceability.

The key challenges in designing a probe for the <5 m range class is space for payload, density constraints, and distribution of weight through the probe body. As the payload of the probe increases, we can also expect the overall weight of the probe to increase. We must offset this increase in weight by increasing the volume (and hence the volume of displaced water, Archimedes' principle), so that we are maintaining some overall density of the probe. This density must match that of the medium for which the probe will be operating (e.g., 1,000 kg/m³ for fresh water, 1,025 kg/m³ for salt water).

This volume-weight ratio (or density) must be preserved as payload is increased (and functionality extended) in order to maintain an overall functional unit (i.e., one that will not sink when placed into water).

As such, given some specified internal volume of the probe, there will be some maximum allowable subset of this volume that we can consume with payload (e.g., we can only fill some certain amount of this internal volume with electronics, batteries, sensors, etc. before we will start to peak the density past the maximum allowable amount). This maximum percentage of consumable volume will be dependent on the density of the internal electronics, batteries, etc.

When designing the internals/payload of the sub extension pieces, it must be ensured that the density of the pieces on their own (that is, volume/mass) is maintained at roughly the same to the rest of the probe body, e.g., if aiming for neutral buoyancy in fresh water then density of each extension piece, modeled as a solid cylinder, must be maintained at around 1,000 kg/m³.

Overall stability and buoyancy must also be maintained, i.e., a bottom-heavy design approach is taken so as to prevent rocking and instability in rough waters. The probe effectively acts as a pendulum in the water. A pendulum will have a tendency to rest at its equilibrium position. A heavily base-loaded probe will act in the same way if external disturbances are imparted on it.

Therefore, as per FIG. 5 in comparison to FIG. 4, when the elongated body is substantially in the range of 1 to 5 meters long allowing for easy maneuverability in small spaces, it is limited in volume and therefore payload. The probe is remotely controlled by wireless connection in real time to the power system and to the visual image capture system for navigational control of the probe. It includes an active ballast system with a ballast controller wherein the underwater probe has a buoyancy value related to the internal volume of the probe and the payload and the active ballast system is remotely controllable through a wireless connection to the ballast controller to allow controlled changing of the depth of the probe.

To be controllable the elongated body needs to retain the hydrodynamic effective shape which is substantially symmetrical for travel in at least two opposing longitudinal directions.

In FIG. 4, the underwater probe has an elongated body with the substantially hydrodynamic effective shape including a first and a second opposing substantially conical heads (12) and a main central part (13) therebetween and aligned along a common elongated axis to allow the hydrodynamic effective shape for travel in at least two opposing directions. The first and/or the second opposing substantially conical heads are detachable and replaceable.

As shown in FIG. 5 the underwater probe can have one or more intermediate parts (14) connectable between the main central part (13) and the first and/or the second opposing substantially conical heads (12) to form a larger internal volume of the probe wherein the payload can be increased. Alternatively or as well, the main cylindrical part (13) can be replaced by a differing length main cylindrical part and attached to the first and/or the second opposing substantially conical heads (12).

Thereby with at least the first and second opposing substantially conical heads having parts of the visual image capture system to allow navigation and the main cylindrical part and/or the one or more intermediate parts having parts of the power system, the probe is modular and has readily connectable and disconnectable modules that can be reconfigured to readily form differing volume and different payload ballast remotely controllable adjustable buoyant probes.

### (a) Batteries

As the size of the submersible does not generally provide sufficient space or weight to power efficiency to allow its own power source, it makes use of batteries (61) in its payload in the central part (13), which receive power intermittently through data and power connectors (41) when the submersible resurfaces and connects to a power source.

The power source for the submersible needs to provide power of the order of 5 kilowatts. For a submersible of the sizing of 1.1 meters with a weight of 15 kilograms. With a submersible of sizing of 2.1 meters the power density will be linear and there will be proportional batteries of 2.1:1.1.

The batteries (61) can be lithium ion batteries but could be other forms. In a submersible of length 1.1 meters, the battery bank (61) in the central portion (13) can be 60% of the payload volume and some 15 kilograms of a total weight of 80 kilograms for the submersible as a whole.

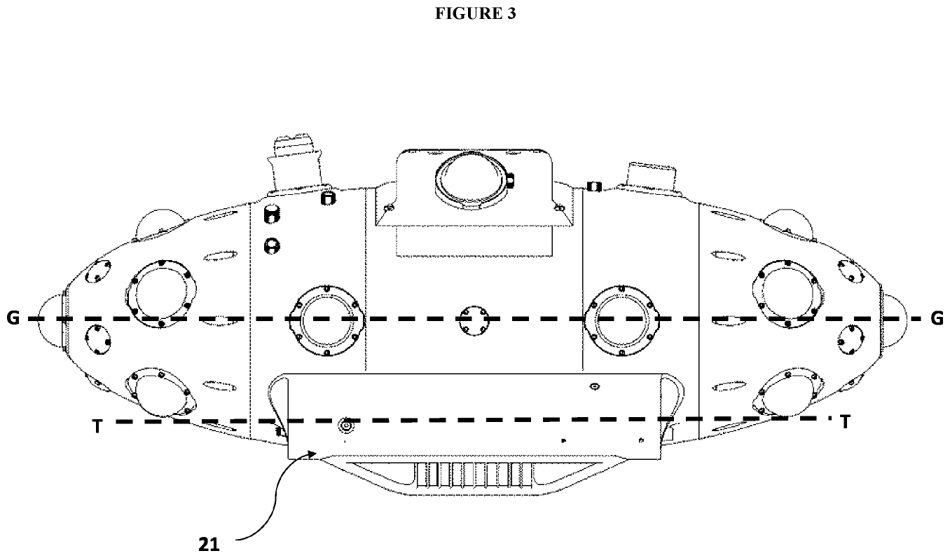

It can be seen that the batteries (61) need to be within the weight that allows ballast (65) to alter the neutral buoyancy. Also, the location of the batteries is important in ensuring the center of gravity G-G of FIG. 3 of the submersible which is at or below the central elongated axis E-E so that the submersible remains stable and readily maneuverable.

### (b) Ballast

The ballast (65) is a ballast tank with a two-way pump (66) (usually one-way pump with two-way switching valve) for allowing water in and water out of the central payload part (13). Ballast is required as the submersible floats due to the weight of water that it displaces being equal to the weight of the submersible. This displacement of water creates an upward force or buoyant force. The submersible, with ballast, can control its buoyancy, thus allowing control of the sinking and surfacing of the submersible.

Generally, the submersible has ballast tanks, that can be alternately filled with water or air. When the submersible is on the surface, the ballast tanks are filled with air and the submersible's submerged density is less than that of the surrounding water. To submerge, the ballast tanks are flooded with water and the air in the ballast tanks is vented or pressurized to alter density until its overall density is greater than the surrounding water and the submersible begins to sink due to negative buoyancy.

A supply of compressed air can be maintained aboard the submersible in air tanks for use with the ballast tanks. However, there can merely be a pumping out of water and decrease in pressure and density. To keep the submersible level at any set depth, the submersible maintains a balance of air and water and pressure and thereby density in the ballast tanks so that its overall density is equal to the surrounding water which is its neutral buoyancy. When wishing to bring the submersible to the surface, compressed air flows from the air tanks into the ballast tanks and/or the water is forced out of the submersible until its overall density is less than the surrounding water and forms positive buoyancy and thereby the submersible surfaces.

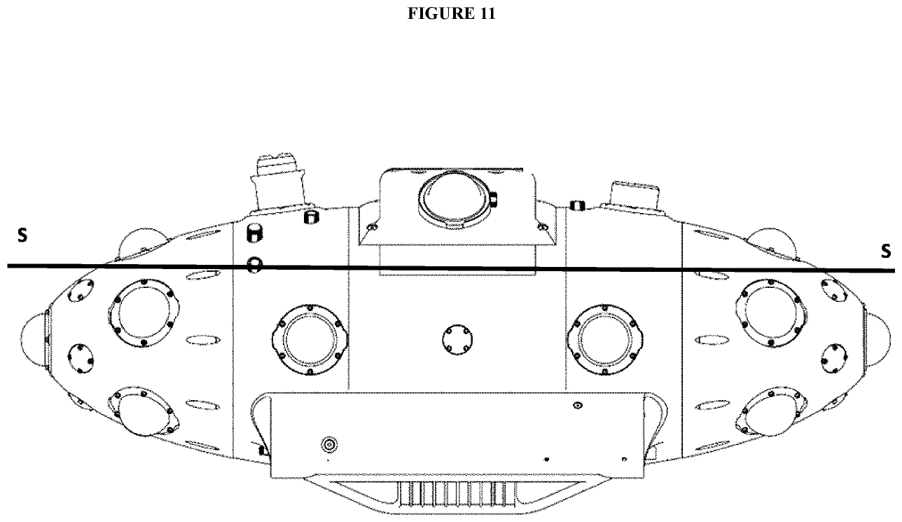

The level of surfacing affects the requirements of the ballast, the compressed air, and the balancing effect. However, the submersible of the invention is only required to surface sufficiently for access to the power and data access ports (41). These are located on a top surface of the submersible and above a surfacing line S-S of FIG. 11 that is above the center of gravity of the submersible. In this way the submersible stays in a settled balanced upright orientation and avoids the tendency to roll. Preferably the surfacing line S-S is in the top quartile of the submersible body.

The ballast system can be a bladder mountable in the body of the submersible, a venting pathway connecting between the bladder and external of the submersible body, a ballast control for controlling the venting in the venting pathway between the bladder and external of the submersible body and a power system for powering the ballast control.

The ballast control uses at least one controllable directional one-way pump and includes at least one switching valve fluidly connected to the one-way pump for switching flow direction in the venting pathway.

By the ballast control including a set of a plurality of switching valves, the set of switching valves work together to resist pressure equally on either side.

Preferably the ballast control includes a set of four switching valves fluidly connected to the one-way pump. The set of four of the at least one switching valves is arranged to form two input switching valves on an input side of the one way pump and two output switching valves on an output side of the one way pump wherein a first of the input switching valves fluidly connects to the venting pathway leading to external of the submersible body and a second of the input switching valves fluidly connects to the venting pathway leading to the bladder; and wherein a first of the output switching valves fluidly connects to the venting pathway leading to external of the submersible body and a second of the output switching valves fluidly connects to the venting pathway leading to the bladder; and whereby the control of input switching valves to have either the first or second input switching valve open and the other closed and thereby feed from either the bladder or external to the input of the one-way pump; to simultaneously control of input switching valves to have either the first or second output switching valve open and the other closed and thereby feed from the output of the one-way pump to the other of the bladder or external.

The pump is preferably a diaphragm pump.

The switching valve is preferably a ball valve.

The control of ballast uses a pressure sensing of the water in the bladder, whereby the actual flow of water in the venting between the bladder and external of the submersible body is precisely determined. The bladder includes an inner expandable bladder and operates in the range greater than 36 psi and preferably in the range from 36 psi to 100 psi.

The combination of bladder system and top mounted thrusters is beneficial. The bladder system can be used for neutral buoyancy trim, with the top thrusters used for ascent and descent (precise depth control). The combination of top thrusters and ballast system is also important for the purposes of energy efficiency, and optimization of motion, e.g., if we intend to descend the submersible to a greater depth, then we can adjust to be heavier than water so that we descend without any further actuation from the top thrusters, thus saving energy. We can then retrim to neutral once we achieve our desired depth. In this case, top thrusters could act as trimming tools, whilst the bladder system could be the primary driver of vertical motion.

Conversely, if we want to resurface, the submersible could simply evacuate the bladder completely, and rise to the surface in a highly efficient manner (without any further control input from thrusters), except if one wanted to control the rate of ascent/descent.

Our mode of operation, using bladder as primary driver of motion with thrusters as trim or thrusters as primary driver with bladder as trim (to trim to neutral), could be switched depending on the types of applications that the submersible is undertaking.

By tying in the use of the horizontal thrusters, we are able to control our surge and yaw as we descend under the effort of the bladder system. If desired, we can adjust our attitude using the bladder system to point the nose of the submersible in a specific direction and use the horizontal thrusters to thrust in that direction.

That is, we use the bladder system to point the submersible and its actuators in a desired direction and run horizontal thrusters to actuate in that direction. This, again, would give us a more efficient form of motion in some situations. The bladder system acts as an attitude actuation method, whilst the thrusters act as a linear actuation method.

This mode of operation could also be extended to be used to align cameras in a particular direction (e.g., dimming the nose to get a better view of a particular underwater object).

The system of bladder and thrusters is designed for both trimming to neutral, as well being the primary driver of vertical actuation. The total volume of the bladder used should be calculated as a percentage of the weight and total density (weight and volume factors) of the submersible, so that it can be used to trim in all kinds of water conditions. As an example, if the submersible has a density of 990 kg/m³ and weight of 100 kg, and we aim to have a bladder volume of 5% (of total weight), this will allow us to adjust our total weight (and hence density) from 100-105 kg. This would allow us to adjust our density to be from 990-1,039 kg/m³. Hence, we could aim for neutral buoyancy in both fresh water (1,000 kg/m³) and salt water (1,035 kg/m³).

Overall, the combination of thrusters and bladder system is beneficial for generating the required types of actuation (mode of operation).

### (c) Electronics

The electronics includes electronics to run the motors (21, 22) as well as to provide guidance through use of the stereoscopic cameras (35) as well as controlling the operation of the monoscopic wide angled cameras (31) for performing visual capture. The electronics collects the data from the visual image capture and is connectable by connector (41) when the submersible surfaces so as to transfer the data and obtain controlling instructions from a mother ship or other central bank.

### (d) Other Payloads

There can be a range of other payloads for use in the submersible or for dispersal from the submersible. These can include differing scientific instruments according to a predetermined experiment or predetermined treatment or regime. It also can include different physical materials or chemical materials or natural materials.

The payload can be operative as a separate submersible (11) or in a coordinated swarm of submersibles (111).

### (e) Motor Location

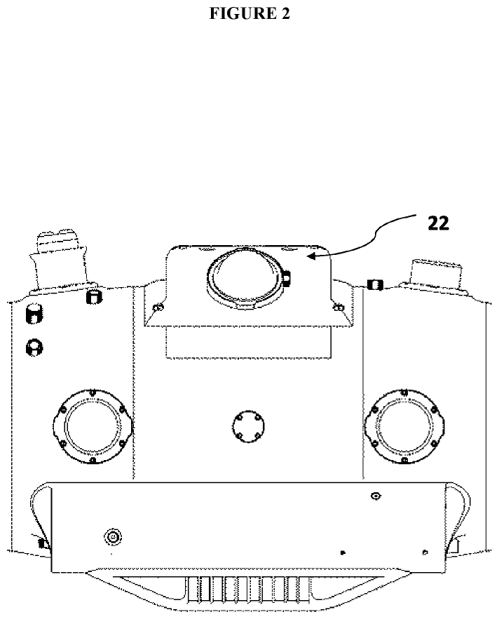

As shown in FIGS. 1 and 2, the power system for allowing the controllable driving of the submersible body is a 3 degree of freedom maneuvering system, where it can move in the at least two opposing directions along the axis of the elongated shape, up and down, left and right. This is provided by two side thrusters (21) on either side of the elongated body and a top thruster (22) on a top surface.

The top thrusters (22) of the power system on the top side of the elongated body include 2 motors spinning in opposite directions to counter the angular momentum of each single motor. The top thruster is placed in the middle of the AUV therefore the force generated from the thruster is very close to the center of mass point, this helps with the control system and reduce complication in the maneuvering control.

The side thruster (21) has a tube-like configuration to decrease the amount of turbulence generated from the thruster. This helps with the ability to take high quality pictures from the camera that are behind the thruster stream.

The two side thrusters of the power system on either side of the elongated body are under the center of gravity plane, wherein the submersible is maintained stable during maneuvering. More preferably, it is in the lower 25 percentile. The thruster force plane is parallel to the center of gravity plane which extends longitudinally down the submersible. With the thruster force being operative longitudinally it provides the primary main bidirectional movement in opposing directions along the elongated axis.

A beneficial element is that the power system can be totally on the central part (12) with the payload of the batteries (61) and controlling electronics (69) also in the central part. In this way the motor is spaced from the primary ring (411) of cameras (31) on the axis A-A or B-B on the nose parts (12) of the submersible.

### Speed and Maneuverability

Velocity of the submersible is in the range of 2.5 to 5 kilometers per hour. This speed is necessary to be within the balance of buoyancy, maneuverability, battery power size, and scanning efficiency.

Overall stability and buoyancy must also be maintained, i.e., a bottom-heavy design approach is taken so as to prevent rocking and instability in rough waters. The probe effectively acts as a pendulum in the water. A pendulum will have a tendency to rest at its equilibrium position. A heavily base-loaded probe will act in the same way if external disturbances are imparted on it.

Another reason to design a probe that is as short as possible (i.e., <5 m) is to maintain a high degree of maneuverability of the probe in tight spaces. In a similar way to how we want to keep the mass of the probe biased toward the bottom half of the probe, we also want to keep the mass as centralized as possible, as this will help to keep the moment of inertia about the center of mass (COM) as small as possible.

A result of this will be an increase in maneuverability and control about the yaw axis of the probe, i.e., much easier.

### Access Points

Referring to FIG. 7, the access ports (41) are on the upper surface of the central part (13) of the submersible and provide data and power connection to the batteries (61) and the electronics (69).

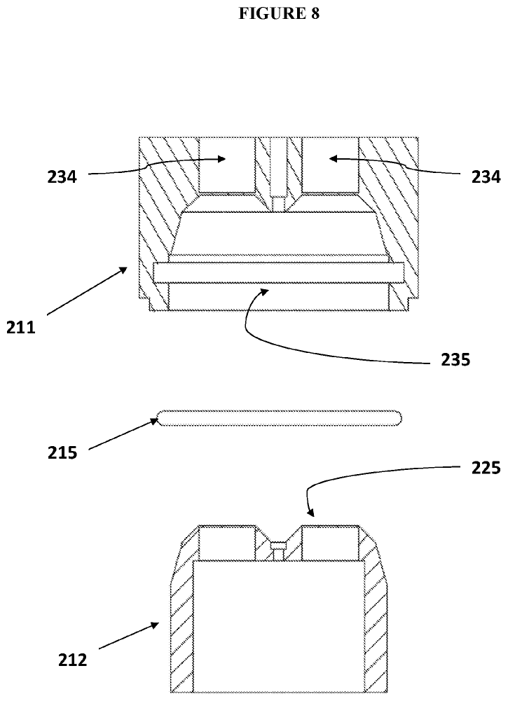

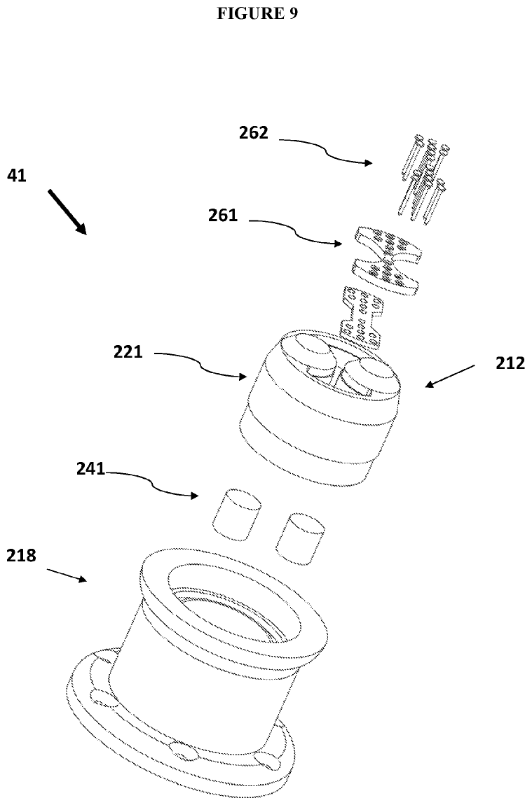

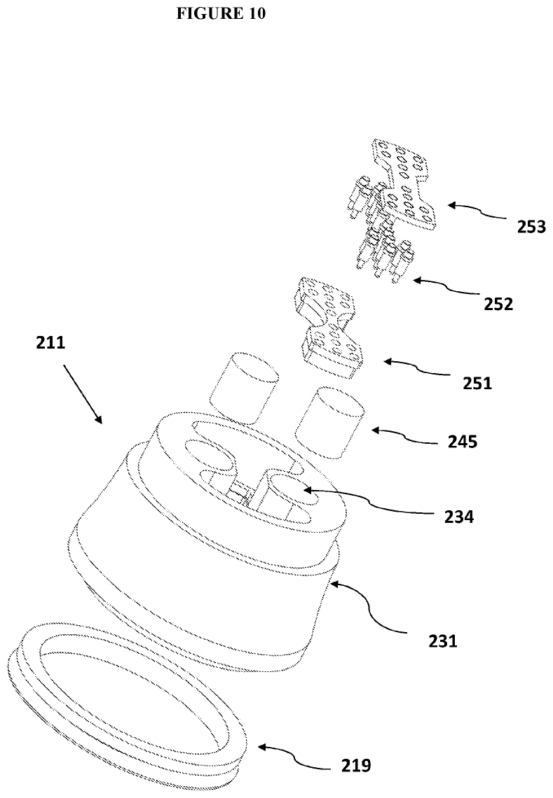

Referring to FIGS. 8 to 10, the access points (41) can be using a connector for connecting data and/or power contacts without tools. This can include a first male connector (212) that connects to a second female connector (211).

The first male connector (212) having a shaped convex outer wall defining an engaging formation and a first orientated one or more magnets (241) in or adjacent the shaped convex outer wall. The first data and/or power contacts are located in or adjacent to the shaped convex outer wall and in a relatively orientated position relative to the first orientated one or more magnets.

The second female connector (211) has a shaped concave inner wall defining a receiving formation and sized and shaped to receive the engaging formation and second orientated one or more magnets (245) in the shaped concave inner wall. The second data and/or power contacts are located in or adjacent to the shaped concave inner wall and in a relatively orientated position relative to the second orientated one or more magnets.

In this way one of each of the first male connector (212) and the second female connector (211) is mountable on a first and second bodies respectively and wherein the first and second orientated one or more magnets can effectively align and connect the first male connector with the second female connector with the first data and/or power contacts (252) connected to the second data and/or power contacts (262).

For connection magnetic material (41) is inserted into the underside of the male connector within the button sections (223, 224) and provide a material for the magnets (245) of the female connector (211) to attach. The male connector (212) is the housing (221) that holds the magnetic material (241), electrically resistive insert (261), and electrically conductive pads (262). The female connector (211) is the housing that contains the sealing material (215 and 219), magnets (245), electrically resistive insert (251), electrically conductive pins (252), printed circuit board (253), and mounting screws (254). The magnet(s) and magnetic material are used to couple and align the female connector (211) to the male connector (212).

It is beneficial to have the male connector connected to the submersible with the female connector able to engage the male connector. In this way the male connector will readily drain away the water when the submersible surfaces to the surfacing level S-S. If the connector attached to the submersible was a female connector it would cup the water as it surfaces and thereby not allow a dry connection of male to female connection parts.

### Visual Image Capture System

### (a) Camera Type

Cameras can be either stereoscopic or monoscopic. To cover a 360° view with minimal effect on the hydrodynamics design as well as minimizing the blind spot it is needed a minimum of 7 to 10 180° view cameras. The objective of camera placement is to make sure that the area of focus is 2 meters from the camera. This is to ensure the best quality image is captured. Although focus on 2 or less than 2 meters is planned the cameras will capture objects that are further away than 2 meters.

The benefit of a stereoscopic camera is that the camera can use its stereo effect to provide a depth of view. This can be particularly useful in directing the underwater probe.

The benefit of a monoscopic camera is that it can be digitally controlled and provide a wide-angle image such as a 180° hemispherical view. Further the images can be more readily digitally knitted together. This is particularly beneficial in providing a panoramic view at a predetermined focused distance or at a predetermined focusing time.

However, cameras to be used can be “wide angle” to the extent that they cover 90° to 180°. This will provide an outward hemispherical viewing angle so that the cameras can sit flat on the body of the submersible and look along the body as well as outwardly. Therefore, the camera is proud of the surface of the submersible, but the degree of proudness is limited so as to avoid overly affecting the hydrodynamics of the submersible.

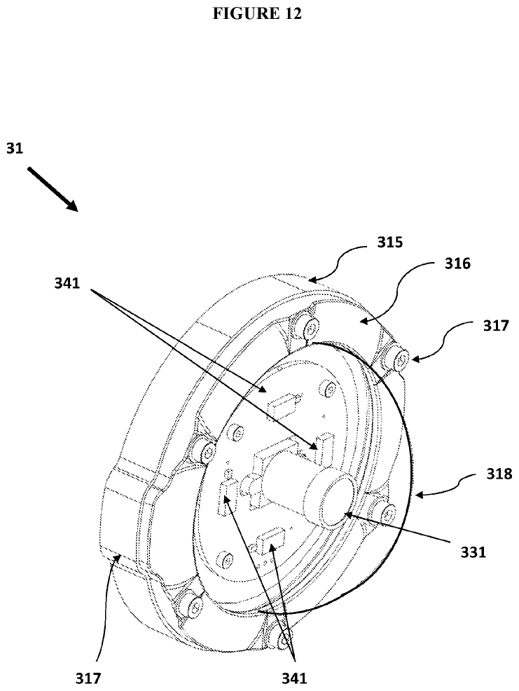

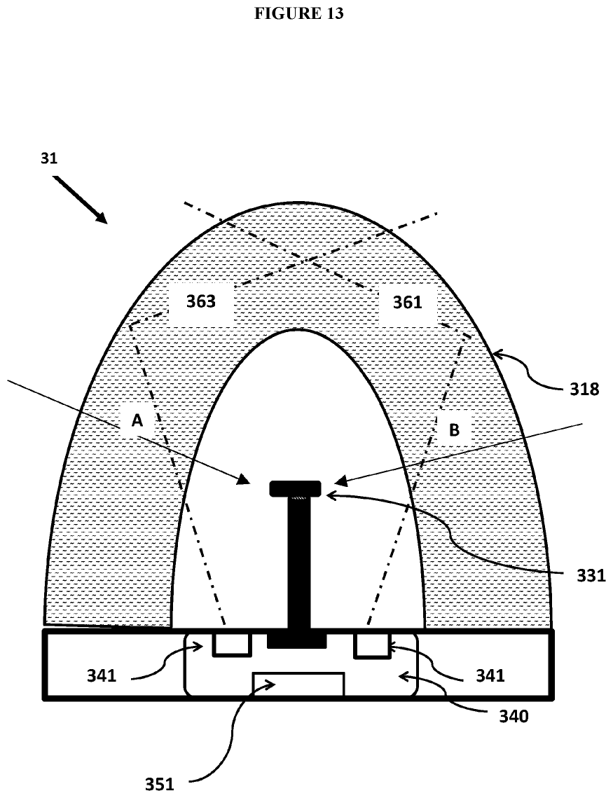

Referring to FIGS. 12 and 13 there are shown monoscopic wide angle cameras that can be used as the wide-angle cameras (31). These also include algae UV radiation cleaning devices.

An optical device (31) such as a camera and in particular a panoramic monoscopic camera mounted in the covering body and arranged for viewing throughout the entire 180° view through the optically transparent window.

Camera unit (31) is the camera(s) within the enclosure space. Dome shape enclosure (318) for the enclosure for the unit that is a dome like shape using a clamping ring (319) to keep the enclosure (318) in place under pressure by being attached to the base (315) by clamping screws (317). A sealing material is used in between the base (315) and the dome (318) to seal the unit upon applying pressure or vacuum.

However, the relative location of the camera (31) to the at least one radiating algae killing light source (341) on the printed circuit board (340) such that the algae killing light sources (341) are rearward of the camera (331) means the camera is not receiving direct light from the algae killing light sources (341). PCB mounting screws (342) mount the PCB (with the algae killing light source [341]) to the base with the camera extending therethrough to fix the relative location of the algae killing light source (341) and the camera (31).

The algae killer uses one or multiple LEDs to generate light sources that are capable of killing algae such as: UV-C, UV-B, near infrared, etc. Preferably the at least one radiating UV cleaning device works in the UV range substantially at the frequency substantially in the range of 270 to 290 nanometers. More particularly the radiating algae killing light source cleaning device works substantially at the frequency of 280 to 283 nanometers. This form is particularly advantageous and novel as it allows for effective cleaning while minimizing the effect on visible light being received by the camera (31).

There can be at least one optical device controller connector for controlling particular input of the plurality of users to the access port of the online means for upload to a computerized means so that there can be operational control of the at least one radiating UV cleaning device controller for controlling transmission of UV at the optically transparent window (318) relative to operation of the camera (31). Preferably the operation of the at least one optical device controller is coordinated with the operation of the at least one radiating UV cleaning device controller to effect cleaning and improve optical effect of the optical device.

### (b) Camera Location

Cameras are located in three main locations. The stereoscopic cameras are located at the end points of the nose parts (12) so as to be the main steering or directional guiding cameras. The second location is on the central part (13) so as to be away from the main set of cameras that are at the third location as a ring of cameras on the nose parts (12) of the submersibles.

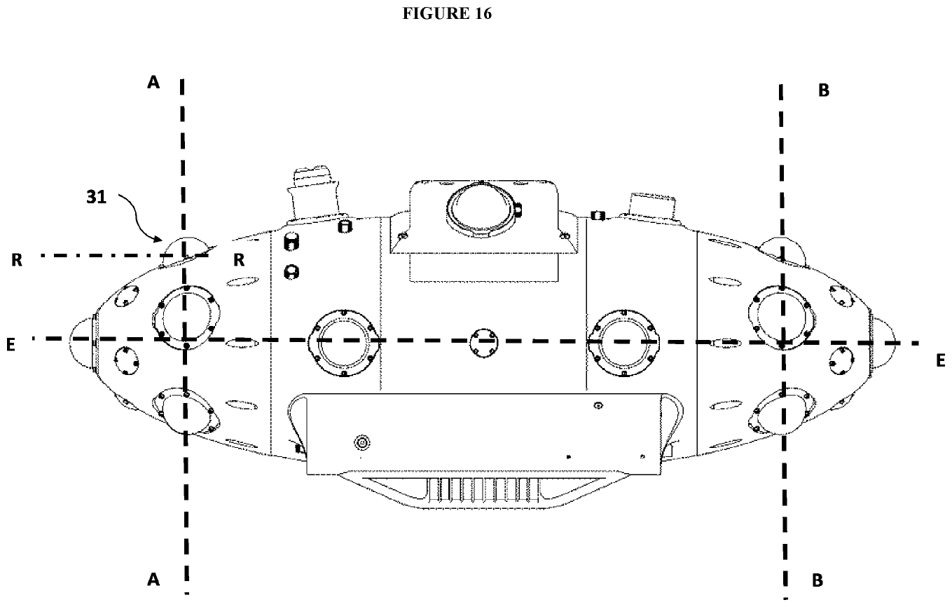

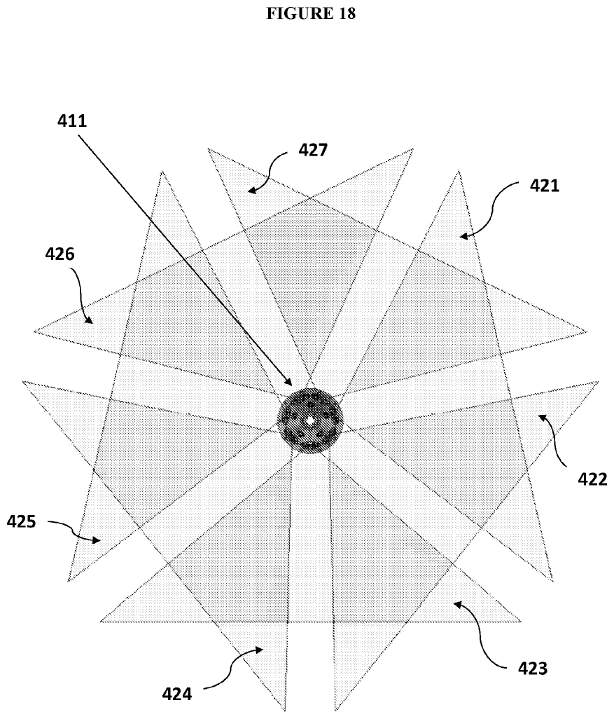

Referring to FIGS. 16 to 18, the arrangement of the 180° optical cameras locatable on the surface of the elongated body around a ring of the nose parts (12) at circumference A-A or B-B.

The spacing of those cameras (31) around the circumference A-A or B-B of the nose parts (12) is dependent on the diameter of the circumference and the tangential effect of the 180° cameras. It is needed to minimize “optical dead spots” by ensuring the tangential line of one camera to the nose body (12) does not extend far from the circumference when it extends to the adjacent camera (31).

If the length of the submersible is of the order of 1 meter, then it is generally not required to include a further fill-in camera on the central part. The greater the length of the submersible beyond 1 meter to the 5 meter limit the more cameras required on the central part (13).

### (c) Camera Orientation

It is important that the location of the primary cameras (31) is linked to each other to provide an effective coordinated effect. It has been found there are two important orientations of cameras. These are a tangential orientation and a rectilinear orientation.

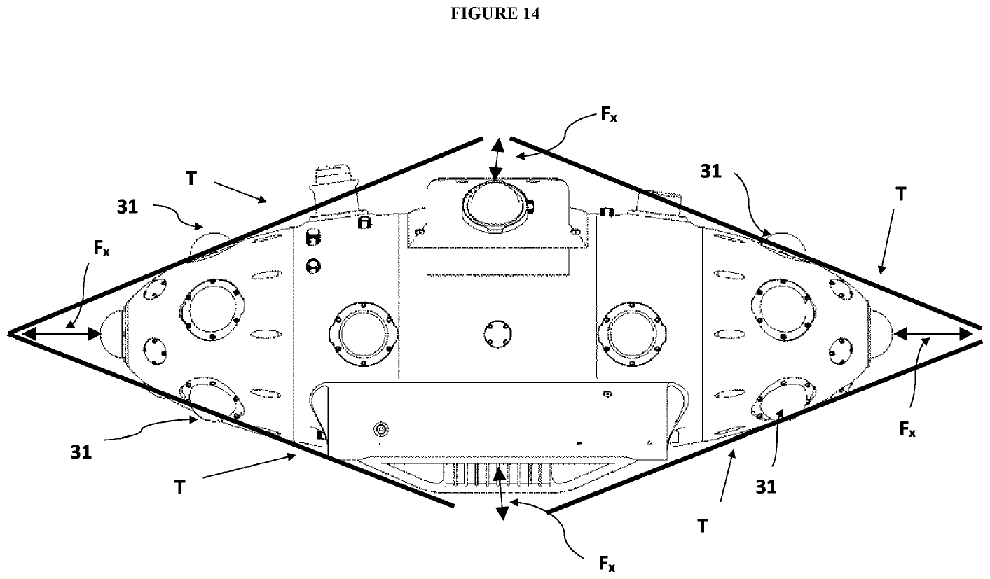

In FIG. 14 the camera (31) orientation is a tangential orientation T to the nose part (12) of the body. A substantial benefit of this orientation is that the angle can be controlled by the shaping of the elongated body so that the tangential line T does not extend away from the body at the central point or the front point any further than F_{X}. In this way if the cameras have a focusing distance of 2 meters, then the distance F_{X} can be 2 meters and for a 1- to 5-meter-long submersible a required tangential angle determines the ovoidness of the shape of the submersible.

However, a substantial disadvantage of this tangential orientation of the camera (31) is that there is a resultant unwrapped plan image (405) of the distorted fisheye image (404) of which only a part (406) can be used in order to be able to stitch together. Clear edging is required to align different images together. Multiple resultant unwrapped plan images (405) are extremely difficult to knit together due to the edge curvature of the flat image. Therefore, this final part (406) is only a small part of the original distorted image (404) or the unwrapped image (405).

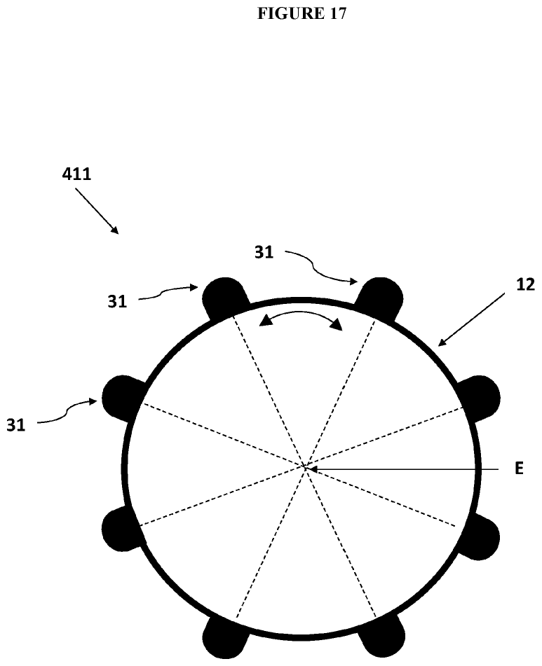

In FIGS. 16 and 17, there is shown how a rectilinear orientation of the cameras (31) is achieved around a circumferential part A-A or B-B on the nose part (12) of the submersible. Instead of these cameras (31) tilting forward as shown in FIG. 14 to follow the line of the body (12) towards the front or back of the submersibles instead these cameras are mounted rectilinear and need to be mounted along line R-R which is rectilinear to the and parallel to the axis of elongation E-E. The effect is that the cameras (31) are thereby no longer linked to the shape of the submersible. Instead, they form a ring that is based on plane A-A or B-B of the cameras. Further as that axis is rectilinear to the primary axis of bidirectional movement of the submersible then all of the capturing is primarily based on the A-A or B-B planes.

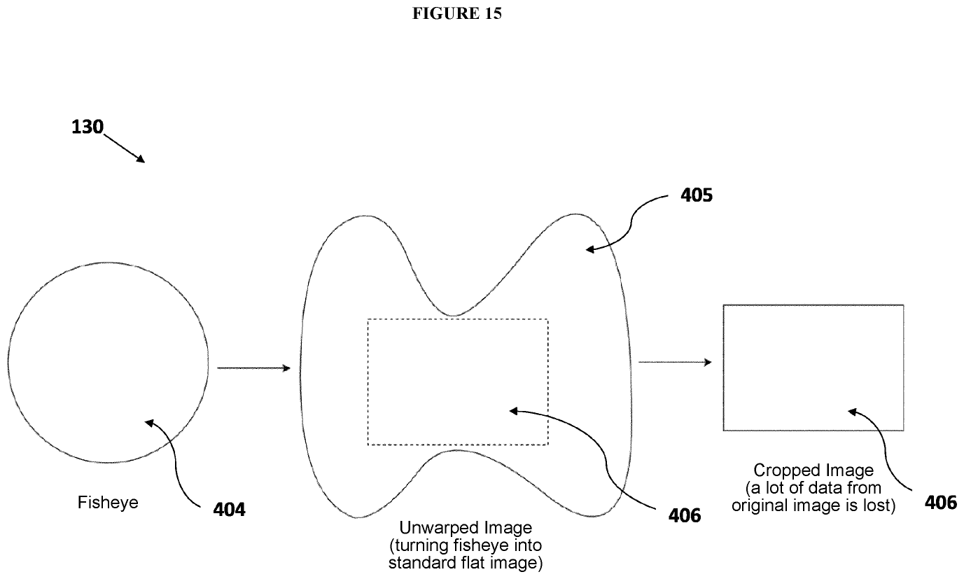

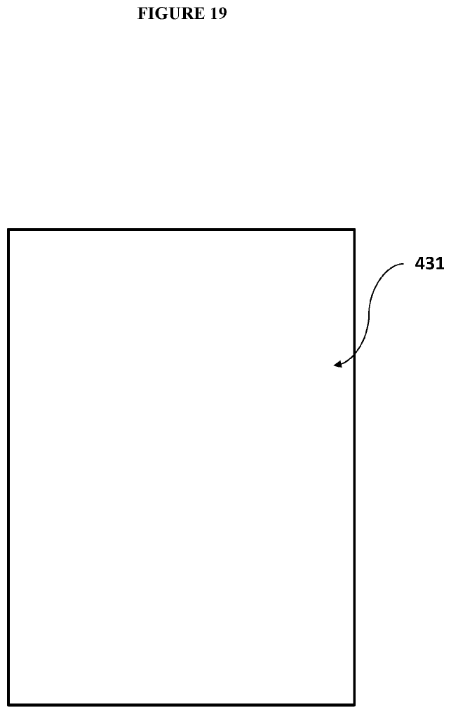

The effect is that the combined image will provide a knitted flat image such as illustratively shown in FIG. 19 rather than the distorted image of FIG. 15.

### (d) Camera Synchronization

By having the cameras aligned in linear circumferential arrangement there is a physical fixed relationship between the cameras. To take advantage of this linear alignment it is also necessary to obtain time alignment or synchronicity.

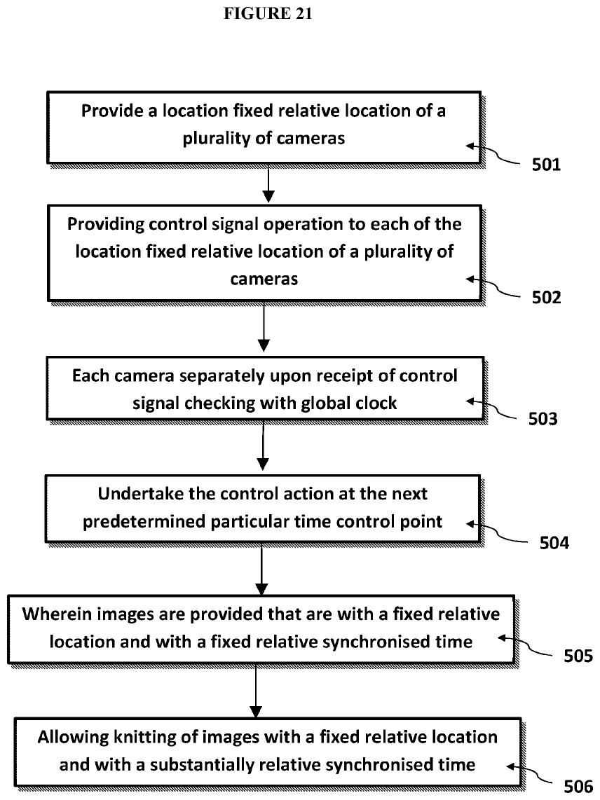

Referring to FIG. 21 synchronicity can be achieved by the method of providing an underwater probe including in step (501) the providing of a location fixed relative location of a plurality of cameras. This is particularly provided by the circumferential array of cameras (31) on nose body (12) of FIG. 14. However, if the operation of the cameras is not coordinated then the submersible will be at a different location than when the other cameras were operated. This would effectively be like having a random location of cameras (31) on the nose body (12).

It is therefore important to have synchronicity of operation of cameras (31). This cannot be achieved simply by logic switches as there is too great a variation of operation due to the physical limitations of electronic switching.

In step (502) there is the providing of control signal operation to each of the location fixed relative locations of a plurality of cameras and then in step (503) each camera separately upon receipt of control signal checking with global clock. In the provided control signal operation, a time control point will be predefined.

In step (504) each camera separately undertakes the control action at the next predetermined particular time control point and results in step (505) wherein images are provided that are with a fixed relative location and with a fixed relative synchronized time and thereby in step (506) allowing knitting of images with a fixed relative location and with a substantially relative synchronized time.

As all cameras (31) are not acting based on the time they are control instructed but instead on a particular control time point. Therefore, if there is an inherent relay delay to a camera it is not affected as long as the time control point is larger than the delay and as long as each camera control is connected to the global clock. In this way synchronicity is within a ±4 millisecond variation.

### (e) Camera Numbers

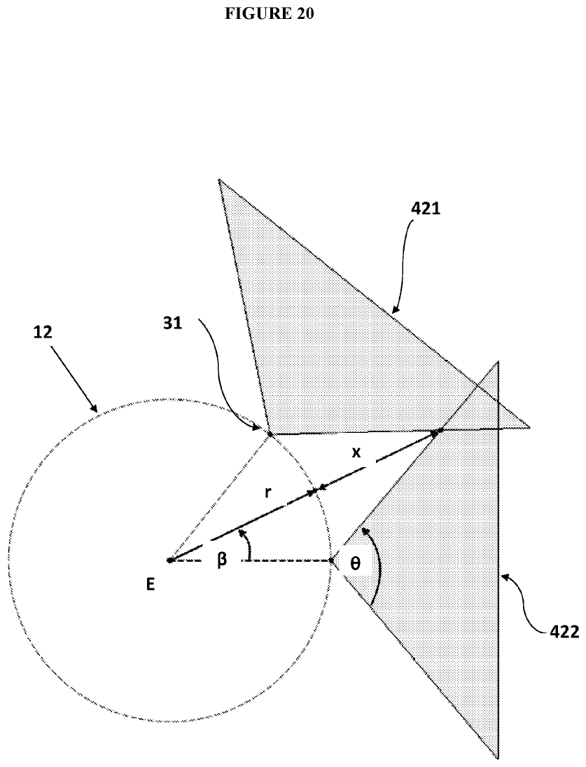

Referring to FIG. 20, the number of cameras N required at plane A-A or B-B is a function of the diameter (2r) of the submersible, the angular spacing of cameras (8) the angle range (θ) of the cameras (31) and the overlap of camera angles. It can therefore be seen that the number of cameras in any 360° along the nose part (12) of the submersible is 360°/β in which the relationship is defined as:

$$x = \frac{r sin ( 180 - \frac{1}{2} θ )}{sin ( \frac{1}{2} θ - \frac{1}{2} β )} - r$$

where:
θ=the camera view angle
x=distance between the camera lens and the first overlap with adjacent camera
r=radius of the submersible at the axis of the cameras
=angular spacing of cameras=360°/N
N=number of cameras

### (f) Knitting of Images

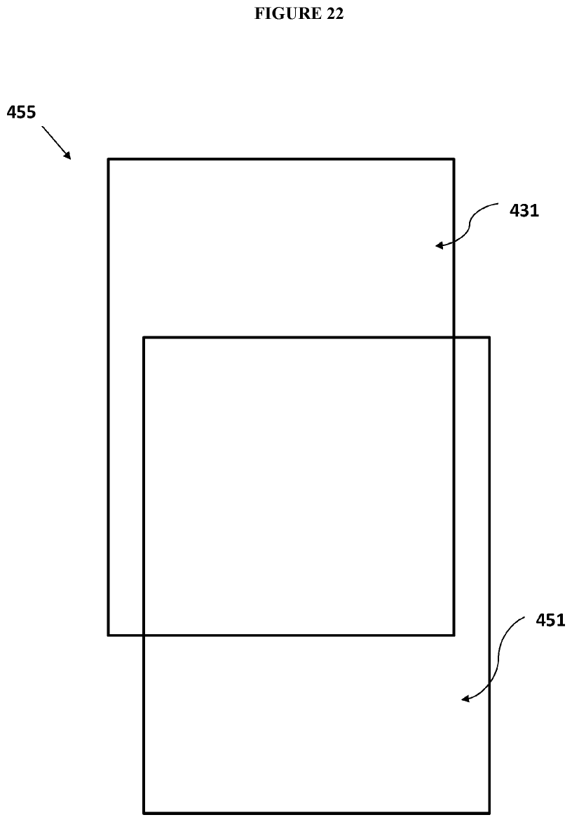

Referring to FIG. 22, there is shown a diagrammatic view of time mapping of images (431) and a later image (451) such as by camera array (411) at ring A-A at one time and at A-A at a later time after the submersible has moved a known distance. This can form a combined image (455) that can add a third dimension or act as a panorama.

In particular this can allow for providing a localized panorama formed by the optical cameras locating an object or the lack of an object in a predefined focused distance from the elongated body and allowing the localized panorama for use in creating an interlinked panorama by the network of underwater probes.

A navigation system can be provided by this relativized panorama formed by the optical cameras locating an object or the lack of an object in a predefined focused distance from the elongated body and within a calculated time and or distance locating an object or the lack of an object in a predefined focused distance from the elongated body allowing the localized panorama.

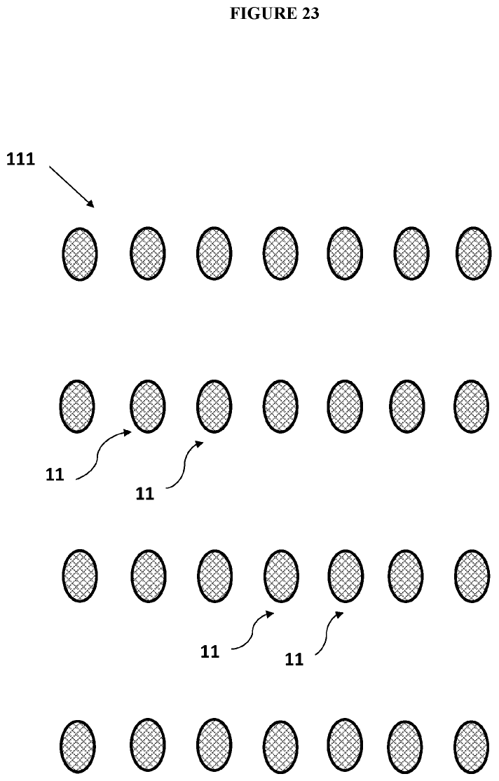

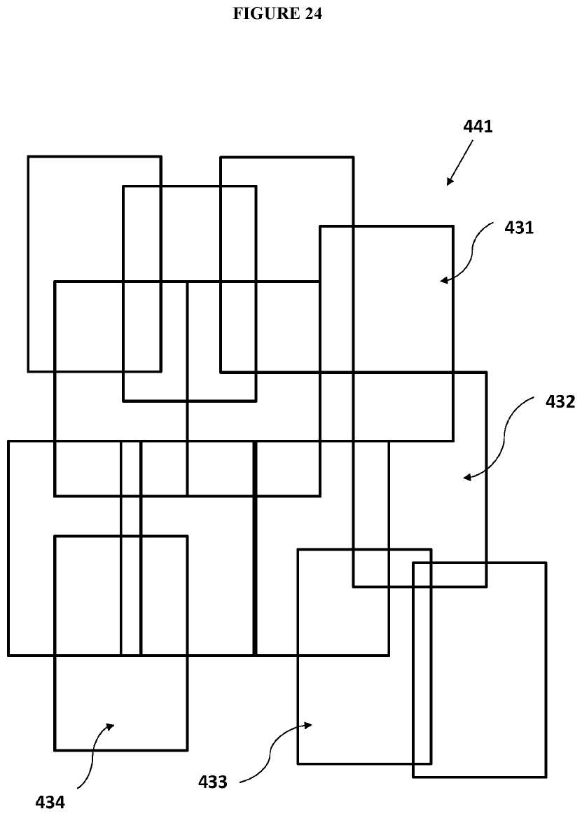

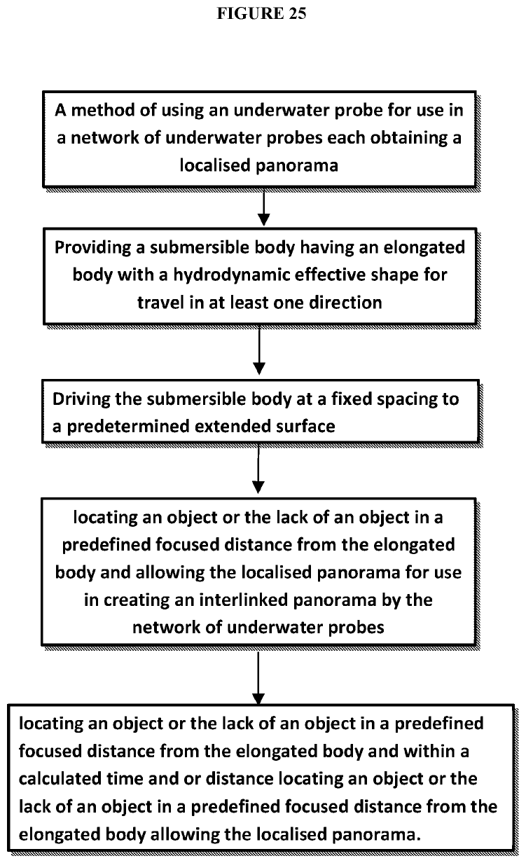

Referring to FIGS. 23 and 24, there is shown a swarm (111) of submersibles (11) which each at a coordinated location and time each obtain their flat knitted image (431, 432, 433, 434 . . . ) which can be knitted together as there is location definition and time synchronicity so as to readily form a knitted map (441).

### EXAMPLES

The core of a UAM is a submarine or submersibles or a swarm of submersibles. These are all linked through proprietary AI technology, together acting as a swarm of mapping units. Each sub is about 1.2 meters long and is built with the intelligence to receive instructions and work out how to map a body of water, either independently or as a unit of a swarm.

At the water's surface, each submersible communicates by encrypted messaging with its satellite network. Each sub reports its location and receives instructions for its mapping tasks. Each sub then dives and navigates its way through its mapping tasks. The subs use onboard sonar, transducers, optical and motion sensors to build a 3D map of the underwater topography and any artificial objects.

Each submersible also carries internal and external temperature and pressure sensors.

Importantly, each submersible can be customized and modularized to carry out specific mapping tasks, for example, seeking a key mineral or seismic issue or pollution source. Each submersible is programmed to avoid damage to natural objects and itself. Submersibles will be able to turn off their sonar when they detect the presence of sonar sensitive life, switching instead to their stereoscopic cameras.

The submersibles work with each other in their swarm to complete wide area mapping projects in high detail and in the short completion durations often critical to a project.

Covering each submersible are 18 to 22 cameras running at 4K 3840×2160 resolution at 30 fps. Proprietary algae killing LEDs keep the picture clear.

Proprietary technology includes custom built power management and charging technologies that allow each sub to stay submerged for more than 22 hours.

As each submersible returns to either a mother ship or shore for recharging; its collected, encrypted data is transmitted to base where our AI platform assembles the 3D maps of what has been seen by each submersible, stitching the maps together to form an unequalled 3D view of what's underwater.

Overall, there is a range of novelty and invention including:
(a) the shape which looks like an American football;
(b) getting all the technologies into a package less than 1.2 meters long;
(c) the best construction materials;
(d) solving issues of maneuverability;
(e) 360-degree movement;
(f) leakages;
(g) power demands of four to six motors; and
(h) the type and number of sensors.

We settled on four motors, sonar not ultrasonics, optimizing propeller design, power supply, sensors, corrosion resistance, dismantling v sealing, ballasting, geolocation coordinate technologies for swarming, algae growth, antenna design, and algorithms. There are proprietary charging design and power management, achieved full 360-degree viewing and scanning, multiple beam sonar, stereo cameras for object sensing, customized battery packs, EMF interference between components, swarm issues, and algorithms completed.

Clearly a person skilled in the art would also see many other improvements that are novel and inventive, and these are included in the scope of the invention.

### Interpretation

### Embodiments

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the particular features, structures or characteristics may be combined in any suitable manner, as would be apparent to one of ordinary skill in the art from this disclosure, in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first,” “second,” “third,” etc., to describe a common object, merely indicate that different instances of like objects are being referred to and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures, and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward,” “rearward,” “radially,” “peripherally,” “upwardly,” “downwardly,” and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e., to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulae given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above that the arrangements described are applicable to the submersible and underwater probe industries.

What is claimed is:

1. An underwater probe, usable in a network of underwater probes, the underwater probe comprising:
a. a submersible body having:
i. an elongated body with a substantially hydrodynamic effective shape for travel in at least one longitudinal direction;
b. a power system for allowing the controllable driving of the submersible body in the at least one longitudinal direction; and
c. a visual image capture system including a plurality of optical cameras located on or at the surface of the elongated body to allow for usage in one or more of:
i. navigation;
ii. a visual capture;
iii. a visual mapping; and
iv. knitting of a composite visual image;
wherein the elongated body is substantially in the range of 1 to 5 meters long allowing for easy maneuverability in small spaces; and
wherein the probe is remotely controlled by wireless connection in real time to the power system and to the visual image capture system for navigational control of the probe for easy maneuverability in small spaces.

2. (canceled)

3. (canceled)

4. An underwater probe according to claim 1 including an active ballast system with a ballast controller wherein the underwater probe has a buoyancy value related to the internal volume of the probe and the payload and the active ballast system is remotely controllable through a wireless connection to the ballast controller to allow controlled changing of the depth of the probe.

5. (canceled)

6. (canceled)

7. An underwater probe according to claim 4 wherein the elongated body with the hydrodynamic effective shape is substantially symmetrical for travel in at least two opposing longitudinal directions and includes a first and a second opposing substantially conical head and a main central part therebetween and aligned along a common elongated axis to allow the hydrodynamic effective shape for travel in at least two opposing directions wherein the first and/or the second opposing substantially conical heads are detachable and replaceable and having one or more intermediate parts connectable between the main central part and the first and/or the second opposing substantially conical heads to form a larger internal volume of the probe wherein the payload can be increased.

8. (canceled)

9. (canceled)

10. (canceled)

11. (canceled)

12. An underwater probe according to claim 7 wherein at least the first and second opposing substantially conical heads have parts of the visual image capture system to allow navigation and the main cylindrical part and/or the one or more intermediate parts have parts of the power system wherein the probe is modular and has readily connectable and disconnectable modules that can be reconfigured to readily form differing volume and different payload ballast remotely controllable adjustable buoyant probes and wherein the main cylindrical central part or the differing length main cylindrical central part or the one or more intermediate parts can include one or more of:
a. batteries;
b. ballast;
C. motors;
d. electronics;
e. data and power connections; and
f. other payloads.

13. (canceled)

14. (canceled)

15. An underwater probe according to claim 1 wherein the power system for allowing the controllable driving of the submersible body is a 3 degree of freedom maneuvering system, where it can move in the at least two opposing directions along the axis of the elongated shape, up and down, left and right, and includes two side thrusters on either side of the elongated body and a top thruster on a top surface wherein the top thrusters of the power system on the top side of the elongated body include 2 motors spinning in opposite directions to counter the angular momentum of each single motor and wherein the two side thrusters of the power system on either side of the elongated body are under the center of gravity plane, wherein the probe is maintained stable during maneuvering.

16. (canceled)

17. (canceled)

18. (canceled)

19. An underwater probe according to claim 1 wherein the plurality of optical cameras of the visual image capture system includes one or more of:
a. a monoscopic camera; and
b. a stereoscopic camera;
wherein the optical cameras include stereoscopic cameras for steering the underwater probe and are located at either end of the elongated body and form part of the hydrodynamic effective shape; and
wherein the optical cameras include monoscopic cameras for visual mapping and are wide angled cameras substantially in the range of 90° to 180° scope and are mounted on the nose part of the submersible.

20. (canceled)

21. (canceled)

22. (canceled)

23. (canceled)

24. (canceled)

25. An underwater probe according to claim 19 wherein a plurality of the monoscopic cameras is mounted in a ring on the surface of a nose part on a plane rectilinear to the longitudinal axis of the submersible.

26. An underwater probe according to claim 19 wherein a plurality of opposing nose parts each have a ring of a plurality of the monoscopic cameras on a plane rectilinear to the longitudinal axis of the submersible wherein the planes of each of the rings is parallel and spaced to each other to provide relativistic scanning at separate timing as the submersible moves in one or other of the opposing directions along the longitudinal axis.

27. An underwater probe according to claim 19 wherein the plurality of the monoscopic cameras is determined by the relationship is defined as:
$$x = \frac{r sin ( 180 - \frac{1}{2} θ )}{sin ( \frac{1}{2} θ - \frac{1}{2} β )} - r$$
wherein:
θ=the camera view angle;
x=distance between the camera lens and the first overlap with adjacent camera;
r=radius of the submersible at the axis of the cameras
β=angular spacing of cameras=360°/N; and
N=number of cameras.

28. (canceled)

29. (canceled)

30. An underwater probe for use in a network of underwater probes each obtaining a localized panorama, the underwater probe comprising:
a. a submersible body having:
i. an elongated body with a hydrodynamic effective shape for travel in at least one direction;
b. a power system for allowing the controllable driving of the submersible body in the at least one direction; and
c. a visual image capture system including a plurality of optical cameras locatable on or at the surface of the elongated body to allow for usage in multiple image capture for use in:
i. providing a localized panorama formed by the optical cameras locating an object or the lack of an object in a predefined focused distance from the elongated body and allowing the localized panorama for use in creating an interlinked panorama by the network of underwater probes; and
ii. a navigation system providing a relativized panorama formed by the optical cameras locating an object or the lack of an object in a predefined focused distance from the elongated body and within a calculated time and or distance locating an object or the lack of an object in a predefined focused distance from the elongated body allowing the localized panorama.

31. An underwater probe according to claim 30 wherein a plurality of opposing nose parts each have a ring of a plurality of monoscopic cameras being wide angled cameras substantially in the range of 90° to 180° scope wherein each ring is on a plane rectilinear to the longitudinal axis of the submersible wherein the planes of each of the rings is parallel and spaced to each other to provide relativistic scanning at separate timing as the submersible moves in one or other of the opposing directions along the longitudinal axis.

32. (canceled)

33. An underwater probe according to claim 30 wherein the at least one input device provides for use in creating an interlinked relativized panorama by digital knitting of each relativized panorama of a network of underwater probes.

34. (canceled)

35. An underwater probe according to claim 33 wherein the panorama is a digitally mapped panorama determined from the interlinked panorama or interlinked relativized panorama.

36. An underwater probe according to claim 30 wherein the elongated body with a hydrodynamic effective shape includes a main substantially cylindrical part and a leading substantially conical head aligned along a common elongated axis to allow hydrodynamic effective shape for travel in at least one direction, wherein the power system for allowing the controllable driving of the submersible body is a 3 degree of freedom maneuvering system, where it can move in the at least two opposing directions along the axis of the elongated shape, up and down, left and right, and includes two side thrusters on either side of the elongated body and a top thruster on a top surface wherein the top thrusters of the power system on the top side of the elongated body include 2 motors spinning in opposite directions to counter the angular momentum of each single motor and wherein the two side thrusters of the power system on either side of the elongated body are under the center of gravity plane, wherein the probe is maintained stable during maneuvering.

37. (canceled)

38. (canceled)

39. (canceled)

40. (canceled)

41. (canceled)

42. (canceled)

43. An underwater probe according to claim 30 wherein the plurality of optical cameras of the visual image capture system includes one or more of:
a. a monoscopic camera; and
b. a stereoscopic camera;
wherein the optical cameras include stereoscopic cameras for steering the underwater probe and are located at either end of the elongated body and form part of the hydrodynamic effective shape; and
wherein the monoscopic cameras are wide angled cameras or panoramic cameras substantially in the range of 90° to 180° scope and are mounted on the elongated body.

44. (canceled)

45. (canceled)

46. (canceled)

47. (canceled)

48. An underwater probe according to claim 43 wherein panoramic cameras are mounted on the elongated body to protrude to allow panoramic views while minimizing effect to the hydrodynamic effective shape.

49. An underwater probe according to claim 43 wherein panoramic cameras are mounted in curved domes with protruding elevation in the range of 4% to 8% of the maximum diameter of the underwater probe around the elongated axis.

50. An underwater probe according to claim 43 wherein the elongated body with a hydrodynamic effective shape includes a main substantially cylindrical part and a leading substantially conical head aligned along a common elongated axis to allow hydrodynamic effective shape for travel in at least one direction and wherein 5 to 9 but preferably 7 panoramic cameras are equally spaced from the leading point of and equally spaced around the 360° of the leading substantially conical head aligned along a common elongated axis.

51. An underwater probe according to claim 50 wherein the leading substantially conical head aligned along a common elongated axis has converging opposed tangential lines that extend to about the required predefined focused distance from the elongated body in front of the hydrodynamic effective shape such that the panoramic cameras are mounted on the tangential line on the hydrodynamic effective shape and thereby can locate an object or the lack of an object in a predefined focused distance in a hemispherical position from the elongated body allowing the localized panorama.

52. (canceled)

53. (canceled)

54. (canceled)

55. (canceled)

56. (canceled)

57. A method of using an underwater probe for use in a network of underwater probes each obtaining a localized panorama including the steps of:
a. providing a submersible body having an elongated body with a hydrodynamic effective shape for travel in at least one direction;
b. driving the submersible body at a fixed spacing to a predetermined extended surface; and
c. undertaking visual capture to undertake:
i. locating an object or the lack of an object in a predefined focused distance from the elongated body and allowing the localized panorama for use in creating an interlinked panorama by the network of underwater probes; and
ii. locating an object or the lack of an object in a predefined focused distance from the elongated body and within a calculated time and or distance locating an object or the lack of an object in a predefined focused distance from the elongated body allowing the localized panorama
wherein the undertaking of visual capture includes the steps of:
a. providing a location fixed relative location of a plurality of cameras;
b. providing control signal operation to each of the location fixed relative location of a plurality of cameras;
c. each camera separately upon receipt of control signal checking with global clock;
d. undertaking the control action at the next predetermined particular time control point;
e. wherein images are provided that are with a fixed relative location and with a fixed relative synchronized time; and
f. allowing knitting of images with a fixed relative location and with a substantially relative synchronized time;
wherein the fixed spacing to a predetermined extended surface is about 2 meters.

58. (canceled)

59. (canceled)
